(19) United States
(12) Patent Application Publication
(10) Pub. No.: US 2005/0010835 A1
(43) Pub. Date: Jan. 13, 2005

(54) Autonomic non-invasive backup and storage appliance

(75) Inventors: Philip Lee Childs, Raleigh, NC (US); Michael T. Vanover, Raleigh, NC (US); Steven R. Welch, Giltoy, CA (US); Ted Bonkenburg, Mountain View, CA (US); Dejan Diklic, Saratoga, CA (US)

Correspondence Address: KELLY K. KORDZIK;WINSTEAD SECHREST & MINICK PC, PO BOX 50784, DALLAS, TX, 75201, US

(73) Assignee: International Business Machines Corporation, Armonk, NY (US)

(21) Appl. No.: 10/618,213

(22) Filed: Jul. 11, 2003

(51) Int. Cl. G06F 12/16; G06F 15/16

(52) U.S. Cl. 714/6; 711/162; 711/112; 709/203

(57) ABSTRACT

A system and method for backup data storage and retrieval which does not require a program to be installed on the host computer system. The system and method may operate over a network. A system and method for automatic execution of the backup and restoration, including installation of a recovery operating system, if desired or required, is also provided. A data structure for the optimization of the storage of backup data is also provided.

### RELATED APPLICATIONS

This Application is related to U.S. application Ser. No. ______, entitled, “Autonomic Image Migration/Deployment Appliance,” filed contemporaneously herewith.

### TECHNICAL FIELD

The instant invention relates in general to a file storage system and method for a computer system. The invention is well-suited to system backup and restore procedures as well virtual network storage needs.

### BACKGROUND

Within the prior art, backup and restoration of a computer system requires relatively large backup software programs (15-25 MB) to make an image of the computer system storage media. Some examples of these programs include softwares offered by XPOINT TECHNOLOGIES and POWERQUEST, each very popular in the art. Installation of these types of programs generally have extensive installation side effects, such as the resizing or creation of partitions on the main system storage media and/or extensive modifications to the computer operating system. These installation side effects can cause incompatibilities with other installed software, can diminish available resources for other computer functions, and makes the installation process more complicated for a user to accomplish. Additionally, the state of the art backup programs do not present a very flexible model of backup storage. Images are typically made of the source, making a partial restoration impossible due to the sector allocation inherent in most file systems.

Similarly, network storage is accomplished in the prior art one of two ways. Under the first model, an extensive agent resides on the node computer system, managing the data interactions with a relatively simple server software on the network server. Under the second model, a smaller agent resides on the node, requiring more extensive server software on the network server to fully manage the data storage functions. Under either model, modifications to the node computer system are required, creating side effects similar to those seen with the backup systems. For proper operation, the network storage systems often require the allocation of storage space to the node network agent program and the modification of the operating system on the node. These side effects result in the same compatibility, storage and complexity issues seen with backup systems.

Both the backup and the network storage functionalities present significant expense to the user desiring to effectively use them. In addition to the expense of acquiring the software for backup and for the network storage, each requires additional hardware resources, installation expense and user training.

### SUMMARY OF THE INVENTION

The instant invention provides an appliance which is suitable for the backup and restoration of a computer system, which may be used locally or in the context of a computer network system. The instant invention features the simplicity of a plug-and-play type technology yet the power to be able to be used within large organizations effectively. As a result, the instant invention provides the unexpected benefits of an easier, more cost-effective backup and restoration model.

The foregoing outlines broadly the features and technical advantages of the present invention in order that the detailed description of the invention that follows may be better understood. Additional features and advantages of the invention will be described hereinafter which form the subject of the claims of the invention. The instant invention offers many advantages over these prior art systems, and presents several additional benefits that will be apparent to the reader skilled in the art.

### DESCRIPTION OF THE DRAWINGS

A more complete description of the instant invention is made with reference to several figures:

FIG. 1 is a system diagram depicting a computer hardware system and its configuration when used in the instant invention;

FIG. 2 is a system diagram depicting an embodiment of the hardware configuration of the instant invention;

FIG. 3 is a system diagram depicting an embodiment of a network hardware configuration of the instant invention;

FIG. 4 is a flow chart drawn in conformance to the ANSI/ISO 5807-1985 specification and depicting backup operations under the instant invention;

FIG. 5 is a flow chart drawn in conformance to the ANSI/ISO 5807-1985 specification and depicting restoration operations under the instant invention;

FIG. 6 is a block diagram depicting the composition and use of the storage address generator in accordance with the instant invention;

FIG. 7 is a system diagram depicting an embodiment of a diversified network hardware configuration of the instant invention; and

FIG. 8 is a data diagram depicting the storage of backup data under the instant invention in a distributed system.

FIG. 9 is a flow chart drawn in conformance to the ANSI/ISO 5807-1985 specification and depicting the procedure for booting from the operating system stored in the appliance.

### DETAILED DESCRIPTION

In the following description, numerous specific details are set forth such as computer programming languages, database structures, computer operating systems, microprocessors, bus systems, integrated circuits, protocols, input/output (I/O) systems, etc., to provide a thorough understanding of the invention. However, it will be obvious to those skilled in the art that the present invention may be practiced without such specific details. In other instances, well-known protocols, data formats, computer equipment, and I/O systems have been shown in block diagram form in order to not obscure the present invention in unnecessary detail. For the most part, details concerning timing considerations, specific languages used, specific database structures used, specific data formats used, and the like have been omitted inasmuch as these details are not necessary to obtain a complete understanding of the present invention and are well within the skills of persons of ordinary skill in the art.

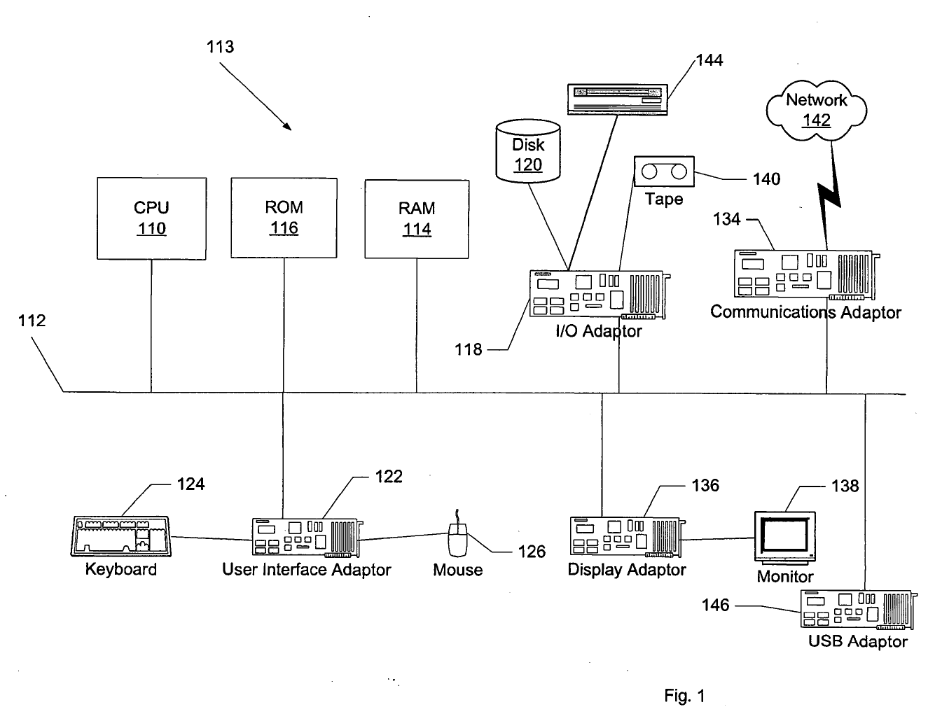

A representative computer hardware environment for practicing the present invention is depicted with reference to FIG. 1, which illustrates a hardware configuration of a data processing system 113 in accordance with the subject invention. The data processing system 113 includes a central processing unit (CPU) 110, such as a conventional microprocessor, and a number of other units interconnected via a system bus 112. The data processing system 113 includes a random access memory (RAM) 114 and a read only memory (ROM) 116. Those skilled in the art will appreciate that the ROM 116 could be replaced or supplemented by a number of semi-permanent chip-based storage devices, such as programmable read-only memory (PROMs), erasable programmable read-only memory (EPROMs), and the like (not shown). Also included are an I/O adapter 118 for connecting peripheral devices such as disk units 120, tape drives 140 and CD or DVD drives 144 to the bus 112, a user interface adapter 122 for connecting a keyboard 124, a mouse 126 and/or other user interface devices such as a touch screen device (not shown) to the bus 112, a communication adapter 134 for connecting the data processing system 113 to a data processing network 142, and a display adapter 136 for connecting the bus 112 to a display device 138. Also, a universal serial bus (USB) adapter 146 may be fitted to the bus 112. The CPU 110 may include other circuitry not shown herein, which will include circuitry found within a microprocessor, e.g. execution unit, bus interface unit, arithmetic logic unit (ALU), etc. The CPU 110 may also reside on a single integrated circuit (IC).

The representative hardware environment depicted in FIG. 1 may be suitable to execute the system to be described. It will be understood that references to a “computer” in this disclosure are to a hardware system similar to that depicted and described with reference to FIG. 1. Those skilled in the art will appreciate that the description with reference to FIG. 1 contains many of the elements common to a computer hardware system, but that a computer hardware system may be operable without every element described in FIG. 1. Accordingly, references to a “computer” may exclude elements disclosed, so long as functionality is maintained. Similarly, modifications and additions may be made to the hardware system, all falling within the definition of “computer” within this specification.

It will be appreciated that the computer disclosed herein is suitable to execute client-side and server-side applications in client-server environments. In such environments, certain adaptations may be made to each computer in order to maximize efficiencies in these respective roles. Further, it will be apparent to those skilled in the art that certain of the computers referenced may be embodied in one or several of the computers as depicted in FIG. 1. Several computers may operate in parallel or in series, filling the function of a single computer and in some cases achieving greater efficiencies.

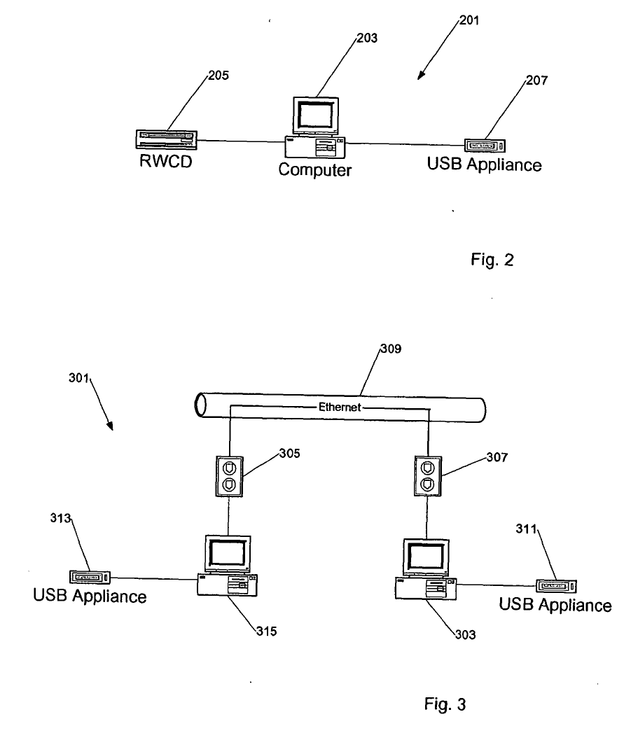

The basic operation and hardware configuration of the instant invention is described with reference to FIG. 2. FIG. 2 depicts a single computer backup system 201 in conformance with the present invention. The single computer backup system 201 comprises a computer 203 that is the subject of the backup or restore procedure. The computer 203 is electrically connected to a program appliance 207. The program appliance 207 may be one of several types of appliances, so long as the appliance 207 provides for at least read-only storage. Shown is a USB appliance 207, connectable to the computer system 203 via a USB interface. The USB appliance 207 is configured so as to appear as a disk drive to the computer 203. A backup program and/or a restore program, of the type and configuration described herein, is stored within the program appliance 207.

The single computer backup system 201 further comprises a data storage appliance 205, electrically connected to the computer 203. The data storage appliance 205 may be one of several types of appliances, so long as the appliance 205 is capable of read/write storage. Shown is a Read/Write CD drive 205, connectable to the computer 203 by means of a typical I/O interface, such as an Integrated Drive Electronics (IDE) interface or a Small Computer System Interface (SCSI).

Generally, pursuant to the invention, the backup program resident on the program appliance 207 directs the computer 203 to copy the files from its hard drive storage system onto the data storage appliance 205. This method of operation is in stark contrast to the prior art, under which a backup program would be installed on the computer 203 which would then instruct the computer 203 to copy data from the computer 203 hard drive to a data storage appliance 205. Similarly, restoration is accomplished via a restoration program (or a restoration function of the backup program), resident on the program appliance 207.

Though two appliances, one for the program 205 and one for data storage 207, are shown on FIG. 2, it will become clear upon further explanation that only one appliance 207 is necessary, though two appliances 205, 207 can be used. If a single appliance 207 is equipped with a read/write capability, such as is the case with a read/write CD drive, a USB hard drive, or similar storage devices, then the single appliance 207 may perform the functions of the program appliance 207 as well as providing a medium for the storage of the data. The single appliance version has several distinct advantages, not the least of which is the simplicity inherent in a backup and restoration solution requiring a single step of attaching the appliance 207 in order to begin and complete the backup or restoration of the computer 203.

Restoration of data backed up on the data storage appliance 205 may be accomplished through the same hardware configuration shown on FIG. 2. The programming on the backup appliance 207 is replaced by or may be supplemented with restoration programming, as will be described hereinafter. The restoration program on the appliance 207 directs the computer 203 to copy data from the data storage appliance 205 to the computer 203.

A hardware configuration of the instant invention in a network environment is show with reference to FIG. 3. FIG. 3 shows a network system 301 having a computer 303 to be backed up. The computer 303 is in electrical connection with a network port 307, which is in turn in electric communication with a network 309. Although the network 309 shown is nominated as an Ethernet network and in block form, those skilled in the art will appreciate that the type and configuration of the network is irrelevant to the operation of the instant invention. Accordingly, the invention could be practiced on any number of network systems, including a token ring system or a system having wireless, hubbed or routed components, without changing the effect of the invention, and all falling within the scope of the disclosure.

The network 309 provides data communication from the computer's port 307 to a second port 305. In electric communication with the second port 305 is a host computer 315. The host computer 315 may be another computer on the network 309 similar to the backup computer 303 or in the alternative may be a computer that is optimized to operate as a server on the network 309.

Under the present invention, a program appliance 311 is placed in data communication with the backup computer 303 (in the same manner as illustrated as to elements 203 and 207 with regard to FIG. 2). The program appliance again contains a backup/restore program which operates in accordance with the instant invention. Prior to or contemporaneously with the attachment of the program appliance 311 to the backup computer 303, a data storage appliance 313 is attached to the host computer 315. Operation of the program appliance 311 is the same as disclosed with reference to FIG. 2, except that data files from the computer 303 to be backed up are transmitted over the network 309 for deposit upon the data storage appliance 313. Similarly, restoration is accomplished similarly over the network 309. As was disclosed with reference to FIG. 2, the appliances 311, 313 are shown as USB appliances, but may be any number of different types of appliances, ranging from USB drives, CD drives (for appliance 311 only), read/write CD drives, and the like. Additionally, it will be appreciated by those skilled in the art that the data storage appliance 313 may be omitted entirely, the data from the backup instead stored directly on the hard drive of the host machine 315. In this embodiment of the invention, it is more likely that the host machine 315 is configured particularly as a server, so as to provide the large storage space and communications buffers which would maximize performance.

It will be appreciated that the use of the invention in the network hardware environment 301 permits the program appliance 311 to be moved from the backup computer 303 to other computers (not shown) connected to the network with relative ease. Accordingly, backups of all of the computers on a network 309 may be accomplished without invasion of the backup computers 303 nor the host/server computers 315 with installed programs which might corrupt, modify or interfere with the proper normal operation of those computers 303, 315.

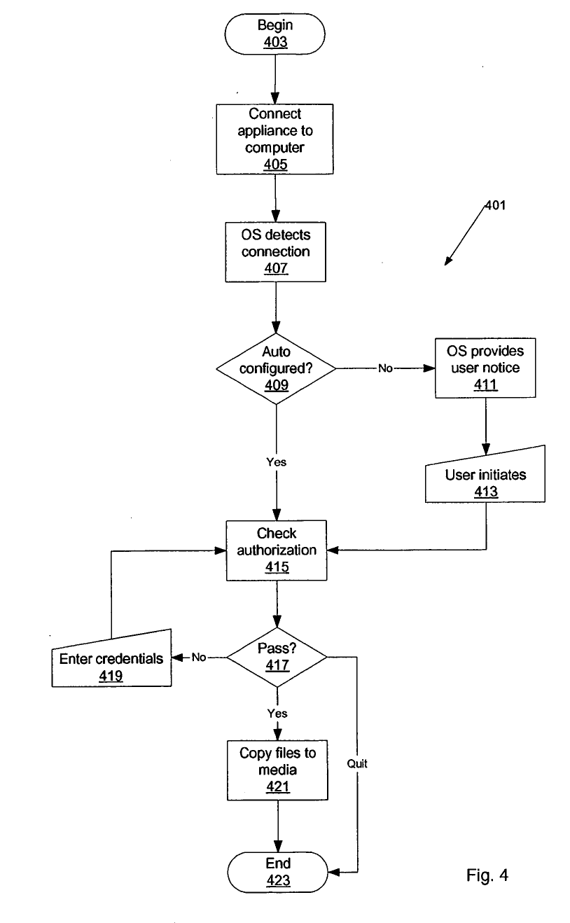

The operation of the backup functions of the program appliance 311 are shown in more detail with reference to FIG. 4. FIG. 4 depicts the method 401 of backup operations. Operations begin 403 with the precondition of a computer system having a hard drive or other media that is in need of backup. First, the program appliance is connected 405 to the subject computer. Upon such connection, the operating system of the computer detects the connection 407. The means for detecting the connection of a new media device are well known in the art, and are typified by the plug-and-play capabilities of operating systems such as Windows XP.

Many operating systems provide not only for detection 407 of the new media made available to a computer, but also provide for the automatic execution of programs placed in specific locations within that media. For example, under Windows XP, inserting a new CD or attaching a new USB drive will cause Windows XP to seek and execute the commands located in the AUTORUN.INF file. By equipping the program appliance with an AUTORUN.INF file in its root directory, the insertion of the new media causes the automatic execution of the backup/restore program resident on the appliance.

Upon the execution of the program resident on the appliance, first the evaluation is made as to whether the program appliance is configured for fully-automatic operation 409. Those skilled in the art will appreciate that this evaluation may be made any number of ways. The appliance program may query the operating system and/or the microprocessor in order to determine the serial number of the machine, comparing that number against a table of configuration parameters, in order to determine whether automatic operation is enabled. In an alternative embodiment, the user may be queried as to whether automatic operation is desired. In yet an alternative embodiment, files may be stored on the backup computer which indicate certain preferences as to the automatic operation of the appliance. Note, however, that the embodiment which places configuration files on the backup computer would no longer provide a system which operated without interfering with the hard drive on the backup computer.

If the program is not set for automatic execution, then the program has the operating system provide 411 notice to the user of the manner in which execution may be activated. Notice may come in several forms. In one embodiment, an icon is provided in a toolbar or desktop. In another embodiment, the user may be provided dialog boxes with instructions on how to activate the program for the backup procedure. In any event, the program operation halts or discontinues until such time as the user manually activates 413 the program. Activation may be by clicking or double-clicking an icon, typing a keyboard command or any other means of signaling the computer to begin or continue a program.

Once the user initiates 413 or, if automatic operation was enabled 409 immediately, the program first checks with the operating system to ensure that the user has sufficient authorization rights to make a full backup of the computer. Typically, operating systems will lock sensitive or system-critical files from the direct access of the normal user. Generally, supervisor or administrator rights, at least as to the local system, will be required in order to make proper access to those system files for copying to any backup media. After inquiry as to the level of access is made, that level of access is checked 417 to ensure that it is sufficient to permit a full backup.

If sufficient authorization is not inherent in the user's login credentials, the user is prompted 419 to enter sufficient credentials to permit access of all of the system files, at least on a read-only basis. Once those credentials are entered 419, they are again queried with the operating system 415 and evaluated to see if they are sufficient 417. The user may exercise the option, if he or she does not have sufficient credentials, to quit the program 423 without having made a backup.

If sufficient credentials are demonstrated, the program copies 421 the files from the hard drive of the subject computer onto the data storage medium. Files are copied on a file-by-file, rather than a bit-by-bit, basis. Accordingly, the files may be stored contiguously on the data storage medium and are retrievable individually or in groups without retrieving the entire backup. Those skilled in the art will appreciate that various compression technologies, well known in the art, including hardware and software-based technologies, may be used to condense the amount of space that the backup files occupy on the data storage medium.

During the copying 421 of the files from the hard drive to the data storage medium, the files may be flagged with the archive bit, if the operating and/or file system is so equipped, to indicate that a copy of the file has been made. Similarly, the system of the instant invention permits the well-appreciated art of incremental backup to be practiced. Under this backup schema, a full backup of the computer is made periodically on a longer time frame (for example, monthly). Between full backups, incremental backups are performed, which only make copies of the files that have changed since the last backup. In this way, much faster backups are possible on a normal, daily basis.

It will further be appreciated that the process of copying the computer data to the data storage appliance may, in an embodiment, also make note of the identity of the backup, the machine and/or time of the backup. This information allows the distinguishing of several sets of backup files within a single data storage appliance. In this way, a single data storage appliance may be used for several backups over time or for the backup of several machines.

The backup operation 401 ends 423 with the post condition of either a completed backup or the generation of an error. Possible errors may be failure of authentication (and the user instruction to quit 417), hardware failure or full data storage errors.

In the normal case, however, the completion of the backup operation 401, if configured for automatic operation and initiated by someone with supervisor credentials, provides a single-step backup (absent any errors) when used in conjunction with the hardware configurations previously described. Moreover, the instant invention provides for such a backup to be made without any modifications to the computer backed up and without the installation of any programs. Such a system provides several non-obvious benefits over the prior art, in which a backup program is installed directly on the computer to be backed up.

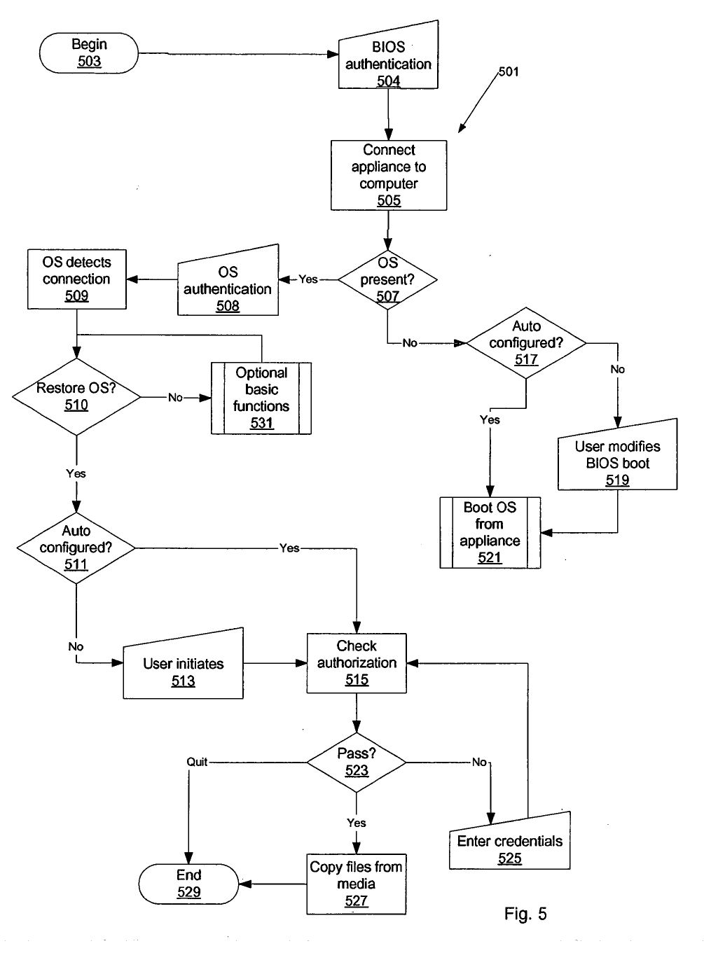

The restoration procedure is shown with reference to FIG. 5. FIG. 5 depicts the restore operation 501 in accordance with the instant invention. The operation 501 begins 503 with the precondition of a backup having been made in accordance with the instant invention. In an optional step that may not be present in some embodiments of the invention, the Basic Input/Output System (BIOS) may prompt the user to authenticate his or her access to the hard drive onto which restoration is required. Execution passes to the next step only upon entry of the proper authentication.

Next, the user connects 505 the program appliance and the data storage appliance containing the backup to the computer. Execution next depends upon the presence of an operational operating system 507. It will be appreciated that in a situation where restoration is desired of a system, there may be times when the existing operating system and/or data files are existing and operational, but corrupt. There may be other times when, for example due to hardware failure, blank media is to accept the restored files. In still other instances, operating system files may exist, but the entire operating system will not be present in an operational form.

In the case of blank media or a non-operational operating system, execution continues depending upon 517 whether the appliance system is set for automatic operation. This inquiry is based upon the availability of the ability of the BIOS in the computer to boot from the appliance. If automatic operation configuration is set, the BIOS is set to boot from the appliance, if present. If not, user intervention 519 is required to properly configure the BIOS to enable a boot from the appliance. It is to be recalled that the appliance may be any number of devices, such as a USB device or CD drive. Accordingly, both the determination 517 of the proper auto configuration settings and the manual setting 519 of the BIOS parameters will vary from instantiation to instantiation of the instant invention, depending upon the nature of the appliance used.

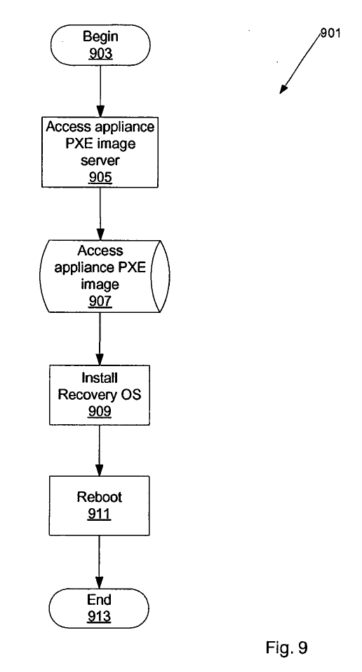

Execution proceeds with the computer booting 521 an operating system from the appliance. Full details of this procedure are described hereinafter, with reference to FIG. 9, but omitted here for the sake of clarity. However, it should be appreciated the basic function, which is to boot the computer with an operating system and install that operating system to the hard drive of the subject computer. The boot-from-appliance process also results in a re-booting of the subject machine.

On reboot, the operation begins 503 again and follows the same execution path as, previously, except that at the determination 507 of the presence of an operating system, the operation finds the installed operating system. Execution proceeds from that point as if an operating system had been found originally during the first iteration.

After an operating system is located 507, the user identifies 508 himself or herself through the authentication methods inherent in the operating system. On login, the operating system detects 509 the presence of the appliance. The result of detecting the appliance 509 is as previously described with reference to the backup procedure, namely that the operating system executes the AUTORUN.INF file or similar automatically-executing file from the media.

The user may be given the option in one embodiment (shown) to elect 510 to perform restoration immediately or not. If the user elects to not perform a restoration immediately, then the user may be given access to a host of optional basic functions 531. These optional basic functions 531 use the installed operating system to provide the user with temporary access to network services, such as e-mail, instant messaging and web browsing, as well as local and remote file access and transfer, and the like. As access may be provided to local files, the basic functions may also be used to re-establish Virtual Private Networking (VPN) connections and other encrypted communications. The optional basic functions 531 may be useful to provide the user access to on-line support services prior to initiating a restore procedure that may permanently delete or modify files. The optional basic functions 531 may also provide a platform through which a user may work to meet or change critical deadlines that might come due while the computer system is otherwise inoperable. The optional basic functions 531 may provide for a directory exploratory system, of the type common to many operating systems, in order to facilitate file operations within the installed operating system. In one embodiment, the directory exploratory system is configurable to mimic the interface provided by the directory exploratory system provided by the user's normal operating system.

Similarly, the optional basic functions 531 may provide a listing of the recently used files and favorite web sites, derived from information residing on the local file system (as these same functions are provided frequently in the normal operating system). As with the directory exploratory system, these lists may be provided to the user via an interface that mimics the user's normal operating system, so as to eliminate the need to learn a new system in order use the computer from the installed operating system. The user may elect to exit the optional basic functions 531, in which case execution returns to the election 510 of the restoration of the operating system.

In an alternative embodiment, the optional basic functions 531 may be omitted, to provide a simpler restoration program with fewer options to the user. In this case, the election 510 of the restoration of the operating system is moot, and execution would proceed with the next query.

The next query made by the system is whether 511 the system is configured for automatic restoration. As with the backup procedure, the selection of automatic configuration may be a previously-made selection which is memorialized in data configuration files on the appliance. However, there may be instances when, for example if only a partial restoration is desired, full automatic restoration is not desirable. Accordingly, automatic restoration may be disabled, in which case the user must manually initiate 513 the restoration procedure. Such initiation 513 may occur in any of the several ways well-appreciated in the art, such as a command line directive or the clicking of an icon.

In either eventuality, execution proceeds to check 515 the authorization for restoration at the computer level. The authority of the user may be derived from the current operating system login or may be separately entered by the user. Alternatively, it may not exist at all, for example in the instance that a new instantiation of the operating system is created on the computer with only a generic login. Unlike prior authorization checks that ensured proper access to the hardware (such as the BIOS authentication check 504) and ensured proper access to the operating system and/or network (such as the operating system authentication check 508), the restoration authorization check 515 ensures that a user has the authority to overwrite the information on his or her hard drive. This authorization helps ensure, particularly in large organizations, that users do not unintentionally or maliciously destroy the contents of their hard drives.

The authorization is evaluated 523 to ensure it is of sufficient level to permit restoration. It will be appreciated that, if a full operating system restore is desired, supervisor-level access will be needed in order to ensure that the operating system files may be overwritten. If access is not of a sufficient level, the user may be prompted 525 to enter additional or new credentials, which are in turn re-evaluated 515 and checked 523 to ensure that they meet the minimum levels required. Optionally, the user may be provided the option to terminate 529 the operation rather than to enter valid authorization credentials.

Once authorization is ensured, the system copies 527 the files from the data storage appliance to the hard drive of the computer. It is anticipated that files will be copied on a file-by-file basis, rather than bit-by-bit, as was the case with the backup procedure. The file-by-file restoration process optionally permits a user to select the files are to be restored, allowing the partial restoration of only certain lost or corrupted files, rather than the entire system. It will further be appreciated that the file-by-file basis allows restoration to be accomplished to a new hard drive, regardless of its similarity to the geometry of the old hard drive. If the backup/restore system disclosed is used in a multiple-computer environment, the system may allow the selection of the backup from one computer onto another computer.

It will be appreciated that this file copying process may occur in several different manners and may use a great number of features already well known in the art. For example, the file restoration process may intelligently track incremental backups and prompt the user for a switch of media in order to ensure the most recent backup is restored. By way of further example, the restoration procedure may restore compressed backup files by uncompressing those files to the hard drive. Each of these and many other backup/restore features well known in the art may be applied to the instant invented system.

The process ends 529 with the post condition of either a partially or fully-restored hard drive on the computer or an error condition (such as failure of authentication).

Detail of the process to boot 521 an operating system from the program appliance is shown with reference to FIG. 9. FIG. 9 depicts the process 901 for booting from the program appliance and begins 903 with the precondition of a non-existent or non-properly functioning operating system on a computer, with the program appliance of the instant invention attached to that computer.

The appliance of the instant invention may be equipped with a Preboot eXecution Environment (PXE) image server. The computer accesses 905 the PXE image server in the same manner in which the computer might access such a server running in a network environment. The PXE server accesses 907 a PXE image stored on the program appliance. The PXE image contains the recover operating system files and specifies their location, in the manner that is already well-appreciated in the art.

The program appliance then causes the computer to install 909 the recovery operating system onto the hard drive of the subject computer. The computer then executes a self-reboot 911. The procedure ends 913 with the post condition of the computer rebooting, which will in turn cause the computer to boot to the newly-installed recovery operating system from the hard drive.

Accordingly, the instant restoration system provides a system which is simple enough to be used by any user and may, in certain embodiments, be programmed to operate completely without user intervention, requiring the user to merely plug the appliance into the computer. The same system, however, can operate with sufficient flexibility and power to permit it to be used within several layers of security to perform complex partial-restoration operations. Even in these cases, however, the described system provides greater simplicity and less room for user error.

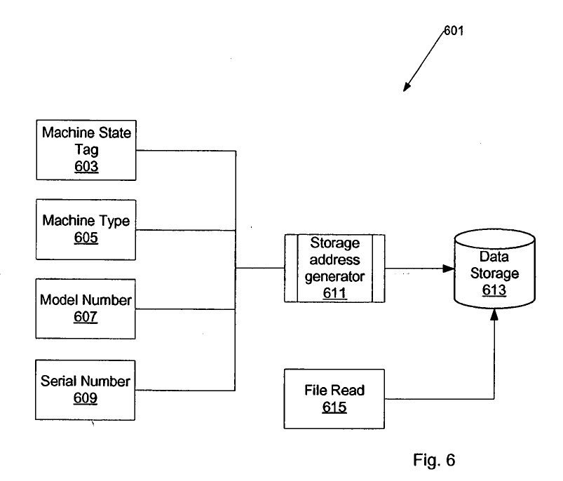

The data structure used by the data storage device and its creation is described with reference to FIG. 6, which depicts the data creation process 601 for the data to be stored on the data storage appliance 613. It is well-appreciated in the art that individual files may be read 615 from the hard drive of the subject computer and written to the data storage appliance 613 in order to accomplish a backup copy of the contents of the hard drive.

The instant invention, however, is suitable for use in multiple-computer environments and may be used to conduct multiple backups of any single or multiple computers. Accordingly, it is necessary to designate the files written to the data storage 613 so that those files may be identified as to the machine and time that they are created.

Accordingly, the data creation process 601 under the instant invention affords for the query of several parameters for storage on the data storage appliance 613. These parameters may be queried in some cases from the operating system, in other cases from a network data source, and in other cases directly from the user. Optimally, however, queries will be made directly from the operating system or the hardware in order to minimize user error and maximize user convenience. The invention may query a machine state tag 603, which identifies the state of the current machine. This machine state tag 603 may include a date and/or time stamp. The invention may also query the machine type 605. The machine type 605 may identify the operating system and version. Other tags may include the model number 607 and the serial number 609 of the computer which is the subject of the backup procedure. It should be appreciated that other parameters, including user-defined parameters, may also be used, such as user name, employee identification number, company department and the like in order to provide information which might be of use later during restoration.

Each of the parameters collected is passed to a storage address generator 611 routine. The storage address generator 611 combines the parameter tags in order to form a storage address, from which all of the parameter tags may be derived during the restoration process. The storage address is stored on the data storage appliance 613 with the files read 615 from the backup computer. The files read 615 are associated with the storage address in the data storage appliance 613. This association may be physical, so that the storage address is physically located adjacent to the copies of the files from the computer. However, in another embodiment, the association is only a logical one, where the files associated with a particular storage address are identified by file name.

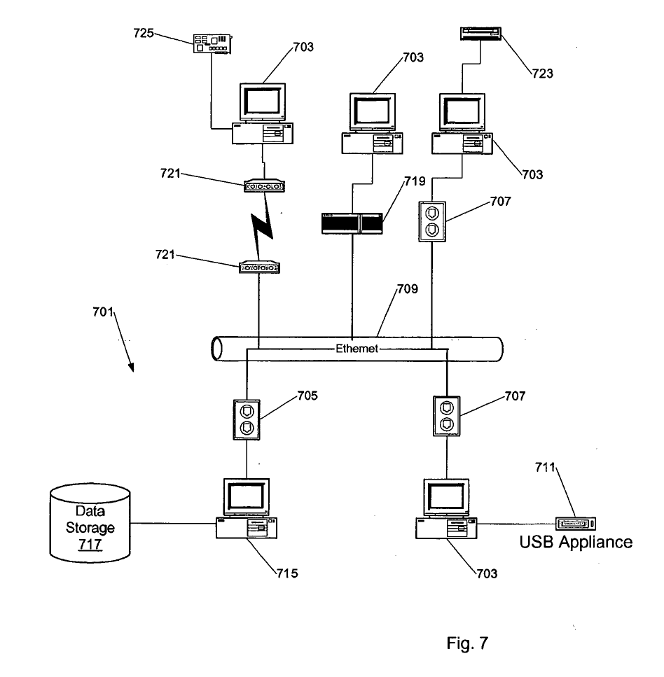

The above-described system is well-suited for implementation in a networked or distributed environment, as demonstrated in FIG. 7 with the extended network 701 depicted. Though the extended network 701 illustrates several types of connections for the purposes of example, those skilled in the art will appreciate those connections are shown merely for example of the flexibility of the instant disclosed system and some of its possible applications. Additional modifications and permutations may be used, all conforming to the instant invention.

The instant invention may be used with several node computers 703 that are in data communication with a common network 709. Some node computers 703 may be connected to the common network 709 directly, via ports 707 directly on the network. The node computers 703 may employ various appliances of the types previously discussed. Notably, however, not all node computers 703 will require the same type of appliance. Some node computers 703 may use USB appliances 711 as the program appliance; others may use CD ROM drives 723 or firmware cards 725 to provide the program of the instant invention to the nodes in a non-invasive fashion. Though the non-invasive version of the instant invention affords certain benefits, it may be desirable in some circumstances to install the program disclosed directly on the hard drive (not shown) of a node computer 703 or on a second hard drive (not shown) within a node computer 703.

The distributed network 701 may employ a particular computer designated as a server 715. The server may be connected to the data storage appliance 717, which may be the disconnectable-type of appliance previously disclosed or may be a separate hard drive or bank of hard drives suitable for storing the backup data. The server 715 may be directly connected to the network 709 via a port 705 or by any other number of means, well-appreciated within the art.

In the distributed network 701, some of the node computers 703 may be located remotely from the network 709. In some cases, a router 719 may provide interface between the network 709 and another network system on which the node computer operates. In other cases, modems 721, satellite links or other telecommunication connections may be utilized to provide remote access from the computer node 703 to the network 709.

The instant invention provides the flexibility for use in such a distributed network system 701. It will be appreciated that the system described previously with respect to FIGS. 3, 4, and 5 will operate transparently of the distributed network system 701, even of the diversity of the one described herein. Accordingly, the instant invention provides great flexibility for use in large or small computer systems and networks.

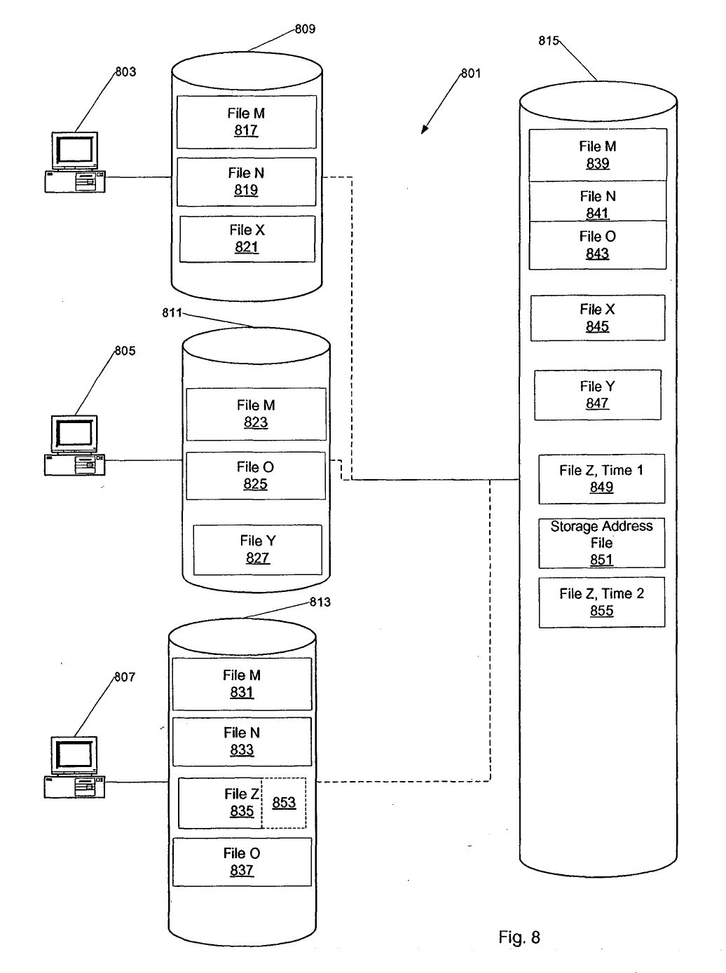

The instant invention provides a means for optimization of the data storage appliance in a manner shown with reference to FIG. 8. FIG. 8 discloses an example 801 of the data storage appliance 815 optimized for use in backups of a set of computers 803, 805, 807 according to the instant invention.

Shown is a first computer 803 having a first hard drive 809 having on it a file M 817, a file N 819 and a file X 821. Though the files 817, 819, 821 are identified singularly, it will be appreciated that any one of them could be substituted with a set of files without affecting the operation of the instant system. Similarly, though three files are shown with simplified file names, more than three files (and likely many more than three files) with much more complex file names may be used under the instant system.

When the first computer 803 is backed up under the instant invention, the program appliance (not shown) attached to the first computer 803 causes file M 817 from the first hard drive 809 to be copied to the data storage appliance 815, where it is stored as file M 839. Similarly file N 819 is copied to file N 841 and file X 821 is copied to file X 845. The storage file address is computed in the manner previously described, associated with file M 839, file N 841, and file X 845, and stored in a storage address file 851 on the data storage appliance 815.

As was previously referenced, a second computer 805 having a second hard drive 811 may also be backed up onto the same data storage appliance 815 under the instant invention. For the purposes of this example, the second hard drive 811 has on it file M 823, file O 825, and file Y 827. It will be appreciated that file M 823 contains the same data as the previously-backed up file M 817. This situation occurs frequently, particularly in the computer systems of large organizations, where identical application and operating system files may be on several computers. The instant invention includes a means to determine whether a particular file to be backed up is already on the data storage appliance 815.

Detection of unity of files may be accomplished via several different methods. A bit-by-bit comparison may be made of files, but such a comparison would require the reading and transmission of the entire file. Portions of the subject file may be subject to bit-by-bit comparison. Unity of files may also be detected by the storage of a checksum in the storage address file 851 and the computation of a similar checksum on the second computer 805. Similarly, the size and date stamp of files may be compared. Combinations of each of these methods may also be used in order to determine which files already exist on the data storage appliance 851.

This example assumes that the files on the data storage appliance 815 are associated with their respective machines on the logical basis previously described, rather than using physical proximity to determine the association. Once it has been determined that file M 823 already exists on the data storage appliance 815, file M 823 need not be recopied. Rather, is annotation is made in the storage address file 851 to associate file M 839 with both the first computer 803 and the second computer 805.

If it is determined that certain files, such as file O 825 and file Y 827 are not present on the data storage medium 815, those files are copied to corresponding files 843, 847 on the data storage medium 815. Updates are made to the storage address file 851 to associate file O 843 and file Y 847 with the second computer 805.

A third computer 807 having a third hard drive 813 may contain several files 831, 833, 835, 837 at a certain point in time. Those files may be backed up to the data storage appliance 815 in the manner described, so that ultimately the storage address file 851 associates file M 839, file N 841, file Z 849 and file O 843 with the third computer 807. As time passes, changes may be made to a file, such as file Z 835, on the third computer 807. While an appendage 853 is shown to file Z 835, it will be appreciated by those skilled in the art that any number of additions, deletions or modifications could be made to file Z 835 over time.

When a second backup is made of the third computer 807 under the instant invention, the instant invention detects the presence and unity of file M 839, file N 833 and file O 837 on the data storage appliance 815. Those files are not recopied, but associated with the second backup time stamp within the storage address file 851. The new file Z 835 and 853, however, is not present on the data storage appliance 815 and is copied to a second file Z 855, being associated with the third computer 807 and the second time in the storage address file 851.

In this way, not only is the time of the backup operation reduced by not requiring transmission of a copy of the file to the data storage appliance 815, but the storage space within the data storage appliance 815 is used more efficiently, permitting more computers to use a single data storage appliance 815.

As to the manner of operation and use of the present invention, the same is made apparent from the foregoing discussion. With respect to the above description, it is to be realized that although embodiments of specific material, representations, databases, and languages are disclosed, those enabling embodiments are illustrative and the optimum relationships for the parts of the invention are to include variations in composition, form, protocol, function, and manner of operation, which are deemed readily apparent to one skilled in the art in view of this disclosure. All relevant relationships to those illustrated in the drawings and this specification are intended to be encompassed by the present invention.

Therefore, the foregoing is considered as illustrative of the principles of the invention and since numerous modifications will readily occur to those skilled in the art, it is not desired to limit the invention to the exact construction and operation shown or described. All suitable modifications and equivalents may be resorted to, falling within the scope of the invention.

1. A backup system for a computer having a hard drive comprising:
a program appliance comprising a program attachable in data communication with the computer; and
a data storage appliance attachable in data communication with the computer,
wherein the program is configured to copy the files from the hard drive to the data storage appliance without installation of the program on the hard drive.

2. The backup system of claim 1 wherein the program appliance and the data storage appliance are the same appliance.

3. The backup system of claim 1 wherein the program is further configured to execute automatically upon the program appliance being attached to the computer.

4. The backup system of claim 1 wherein the program is further configured to copy the files from the data storage appliance to the hard drive without installation of the program on the hard drive.

5. The backup system of claim 1 further comprising:
a network in data communication with the computer; and
a server computer in data communication with the network,
wherein the data communication between the data storage appliance and the computer is provided through the server.

6. The backup system of claim 5 wherein the program is further configured to copy the files from the data storage appliance to the hard drive without installation of the program on the hard drive.

7. The backup system of claim 5 wherein the program is further configured to execute automatically upon the program appliance being attached to the computer.

8. A computer-readable medium having stored thereon a data structure comprising:
a storage address table; and
a plurality of files,
wherein the storage address table identifies a first backup with which a first set of the plurality of files is identified, and
wherein the storage address table identifies a second backup with which a second set of the plurality of files is identified, and
wherein files common to the first backup and the second backup are represented only once within the plurality of files.

9. The computer-readable medium of claim 8 wherein the first backup and the second backup are performed as to a first computer and a second computer, respectively.

10. The computer-readable medium of claim 8 wherein the first backup and the second backup are performed as to a first computer at a first time and at a second time, respectively.

11. The computer-readable medium of claim 8 wherein the storage address table comprises a set of file names.

12. The computer-readable medium of claim 11 wherein the storage address table is further comprised essentially of:
a computer state tag;
a computer type;
a model number; and
a serial number.

13. A computer-readable medium having stored thereon computer-executable instructions executable upon the attachment of a program appliance to a computer and for performing the steps comprising:
checking the authorization of a user; and
copying files with reference to a data storage appliance.

14. The computer-readable medium of claim 13,
wherein the step of copying files is done to the storage appliance.

15. The computer-readable medium of claim 13 wherein the step of copying files is done from the storage appliance.

16. The computer-readable medium of claim 15 having stored thereon computer-executable instructions for performing the steps further comprising installing a recovery operating system.

17. The computer-readable medium of claim 13 having stored thereon computer-executable instructions for performing the steps further comprising selecting a set of files to be copied.

18. The computer-readable medium of claim 16 having stored thereon computer-executable instructions for performing the steps further comprising providing a set of basic functions to a user.

19. The computer-readable medium of claim 18 wherein the set of basic functions comprises file access.

20. The computer-readable medium of claim 18 wherein the set of basic functions is comprised essentially of:
transfer of local and network files to a removable media;
access of local and network files;
e-mail; and
instant messaging.

21. The computer-readable medium of claim 18 wherein the set of basic functions comprises access to encrypted media.

22. The computer-readable medium of claim 16 wherein the step of installing a recovery operating system is performed with reference to a PXE image.

23. A method for backing up a computer system comprising the steps of:
a user connecting an appliance to the computer system;
an operating system on the computer detecting the presence of the appliance;
the operating system executing a program stored on the appliance without storing the program on the computer system;
the program checking the user's authorization level;
the program copying files from a hard drive within the computer system to a data store; and
the user disconnecting the appliance from the computer system.

24. The method of claim 23 wherein the data store is the appliance.

25. The method of claim 23 wherein the data store is within a second appliance.

26. The method of claim 23 wherein the data store is accessible via a network, the network being in data communication with the computer system.

27. The method of claim 23 further comprising the steps of:
the user subsequently attaching the appliance to the computer system;
an operating system on the computer detecting the presence of the appliance;
the operating system executing the program stored on the appliance;
the program checking the user's authorization level; and
the program copying files from the data store to the hard drive.

28. The method of claim 23 further comprising the steps of:
the user subsequently attaching the appliance to the computer system;
a BIOS on the computer detecting the presence of the appliance;
the BIOS executing a boot program stored on the appliance;
the boot program copying a temporary operating system from the appliance to the hard drive;
the computer rebooting; and
the program copying files from the data store to the hard drive.

29. The method of claim 27 wherein the data store is the appliance.

30. The method of claim 28 wherein the data store is the appliance.

31. The method of claim 28 wherein the data store is accessible via a network, the network being in data communication with the computer system.
